(19) United States
(12) Patent Application Publication
(10) Pub. No.: US 2019/0286090 A1
(43) Pub. Date: Sep. 19, 2019

(54) Intelligent Power Distribution Management System and Method Of Use

(71) Applicants: Isac Tabib, White Plains, NY (US); Mohammad Mehdi Daryadel, Sanford, FL (US)

(72) Inventors: Isac Tabib, White Plains, NY (US); Mohammad Mehdi Daryadel, Sanford, FL (US)

(21) Appl. No.: 16/181,538

(22) Filed: Nov. 6, 2018

Related U.S. Application Data
(60) Provisional application No. 62/644,688, filed on Mar. 19, 2018.

(51) Int. Cl. G05B 19/042

(52) U.S. Cl. CPC G05B 19/0428; G05B 2219/2639; G05B 2219/25357

(57) ABSTRACT

An intelligent power distribution management system and method of use for intelligent control of power door locks and any other devices requiring managed power to enhance installation setup, increase functionality and versatility, include local diagnostic computation, extend communication capability for remote monitoring and control, monitor load conditions with the ability to signal and enact protective action as well as alert a user via alarms and LED indicators. The electrified power lock manager is remotely programmable and has a programmable controller, digitally controlled auto resetting solid-state circuit breakers, intelligent detection and measurement of power door lock voltage and current, and the ability to provide early detection of power door lock failure while sending a notification when detecting a failure.

### FIELD OF THE INVENTION

The present invention relates generally to the field of individual entry or exit registers and more specifically relates to controlling and registering access of persons to restricted areas or devices.

### BACKGROUND OF THE INVENTION

Intelligent power distribution management systems are commonly used for many applications including access security as well as fire safety evacuation enablement. As sophistication grows in the form of advanced hardware and software, control of intelligent power management distribution system improves. To date many improvements have been made including programmable control via both wireless and wired communication.

Existing intelligent power management distribution systems control various voltage outputs such as 12V and 24V with current limit protection. Voltage and current output capacity is switched in and out by the intelligent power management distribution system. Current limiting set points are load dependent. Excessive current triggers a disconnect of the power to the load. This disconnect is often in the form of a dry relay or fuse that has to be manually replaced. Other manual control functions include powering of fail-safe or fail secure electric locks as well as dry contact signaling. Fail safe operation unlocks a door if power is lost. Fail secure keeps a door locked if power is lost. Dry contact signaling is used to trigger a relay or solenoid that activates a door lock.

Existing intelligent power management distribution system designs lack an automatic ability to restore power to the field device after a short circuit or overload condition has been corrected as they use standard fuse that must be manually replaced. Prior art shows that corrections of short circuit or circuit overload in electric door locks must be performed manually onsite thus requiring a site visit by a technician. Current power management distribution systems also lack the ability to predict a component failure as failure mechanisms enact a system shutdown when a threshold limit is exceeded rather than measure and analyze potential failures.

Various attempts have been made to solve problems found in intelligent power management distribution systems. Among these are found in: U.S. Pat. No. 6,816,758 to Maxwell, Jr., et. al., who disclosed a programmable controller that is capable of interfacing with a remote master controller, where the programmable controller is capable of controlling an input current to at least one load that is proximate the programmable controller. The programmable controller includes at least one solid-state switch capable of controllably altering the input current to the loads. The programmable controller also includes at least one measuring element for measuring at least one parameter associated with the loads and the solid-state switches, such as the current through the solid-state switches, the current through and voltage drop across the loads and/or the temperature at or around the solid-state switches. Additionally, the programmable controller includes a processing element capable of controlling the solid-state switches, such as by controlling the current through the solid-state switches to the loads.

Power management distribution system methods for predicting failures thus far have only been related to comparison of data to a threshold. Many loads have tolerance variations that are distributed resulting in some load parameters being farther than others from the threshold level. Often times these variances are not drastic enough to be indicative of a failed part. Current systems lack the ability to monitor initial component parameters or record and predict changes in component behavior over time. Monitoring of measured load changes offers improved reliability and longer product lifespan while providing the user with meaningful information about the status of field devices that are connected to the controllers. This information is vital to maintaining operation until maintenance can be performed. Programmability and memory storage of data expands options for gathering as well as storing and analyzing data, especially data in relationship to loads and the historic performance of the load. Programmability working together in functional combination with stored historic data enables intelligence to be implemented for recognizing changes in load data over time. Local computational capability allows for immediate decision and control as well as providing results such as power consumption and real-time status control during events such as loss of signal situations. All of these predictive features offer the advantage of maintaining operation and alerting a user versus existing power management distribution systems that fully shut down when a threshold is reached.

Advances in communication enable native RS-485 wired connection to a controller as a means for feeding back data measurement information and feeding forward control signals. Existing RS-485 connection schemes limit functionality while complicating wiring. Software applications communicated over Ethernet, WiFi, and Bluetooth expand control beyond dedicated instruments to smart phones, computers, and tablets. There exists a need for the measurement and communication of real time as well as historic information such as power consumed, voltages and currents along the power distribution path in intelligent power management distribution systems. In electric door lock applications this need extends to control of relays and enabling decision making based signals such as fire alarm inputs. The features listed thus far would greatly enhance fail safe and fail secure electric door lock operation.

None of the above inventions and patents, taken either singly or in combination, is seen to describe the invention as claimed. Thus, a need exists for a reliable, intelligent power distribution management system, and to avoid the above-mentioned problems.

### SUMMARY OF THE INVENTION

The present invention advantageously fills the aforementioned deficiencies by providing an intelligent power management distribution system and method. The present invention is superior to other systems in that it effectively is configured with features that enhance installation setup requirements and minimize installation duration, increase functionality, visibility, and versatility, include local diagnostic computation, extends communication capability to wired Ethernet, and wireless WiFi and Bluetooth when used in functional combination with a smart uninterruptible power supply, offers extended control to electric door locks, and monitors load conditions with the ability to signal and enact protective action, automatically recover from faults, as well as alert a user of a shorted or reverse polarity output as well as a potential load failure. Collectively, these enhancements and features provide for easy remote maintenance and programmability, away from the site, thus minimizing ongoing support costs while providing for shorter response time by simply executing a command via a communication protocol such as Bluetooth, WiFi, Ethernet, or RS-485. For example, remote and automatic resetting by digitally controlled auto resetting solid-state circuit breakers in the event of load current overload or shorting eliminates the need for a technician to make a service call merely to replace a fuse.

The disclosure provides an intelligent power management distribution system and method of use for enhancing installation and reliability as well as control and monitoring of electronic door locks and associated controls. The exemplary embodiment is optimized for providing eight “wet” voltage outputs to electric locks on security doors and signaling loads such as fire alarms, as well as powering additional loads which may include yet are not limited to motion sensors, PLCs, cameras, lights, relays, and sensors. The intelligent power management distribution system includes programmable inputs and LED lights with illumination colors associated with monitored parameters.

The intelligent power management distribution system includes a programmable controller, twelve supervised dry contact inputs two programmable, general purpose inputs; and eight programmable inputs for triggering programmable outputs; two RS-485 communication ports each having an API protocol; four onboard form C relays rated at 10 A; four wet trigger inputs for the form C relays; eight “wet” DC outputs with preset current limits each having a “wet” output voltage jumper selector for 12V or 24V output voltage levels, a digitally controlled automatically reset solid-state circuit breaker per output capable of measuring and signaling load current having dual color output LED indicators having a first LED color when illuminated indicating normal operation and a second LED color when illuminated indicating overload/short conditions; two input power LED indicators indicating output power of 12V or 24V each having a third LED color indicating the presence of an input voltage; one Fire Alarm LED indicator indicating fire alarm status; a fourth LED color indicating the fire alarm status; two RS-485 LED indicators each having a fifth LED color indicating the presence of an RS-485 bus connection; two auxiliary power port LED indicators having a sixth LED color indicating the presence of a voltage on the power port; a DC Power IN connector; an unmanaged power output connected directly to DC Power IN connector; an onboard “Fail Safe” DIP switch including a plurality of switches; an onboard programmable RS-485 address DIP switch including a plurality of switches including an A setting switch, a B setting switch, and four address setting switches; and a local/remote interface.

The programmable controller has an algorithm that includes alarms and events reporting via dry contacts, and real-time diagnostic and reporting capability. The smart uninterruptable power supply works together in functional combination with the intelligent power management distribution system to supply the input voltage, the eight “wet” DC outputs that are configured for either Fail Safe or Fail Secure operations. The first LED color when illuminated, second LED color when illuminated, a third LED color, fourth LED color, fifth LED color and a sixth LED color are all different colors each indicating a specific status as a means for providing quick information to an observer. The smart uninterruptable power supply is provided a separate RS-485 connection for dedicated communication correspondence that is used to program current limits in the digitally controlled circuit breakers. The programmable controller of the intelligent power management distribution system includes real-time diagnostic capability and automatic recovery from reverse polarity situations for inputs and outputs. The inputs of the intelligent power management distribution system are managed (on/off) by an external dry contact and (on/off) by an OSDP RS-485 command.

The intelligent power management distribution system is configured to record and store load data including output voltage and load current levels over time for power door lock loads and recognize differences in load current based on the historic changes in the stored data as a means for determining component aging and/or failure. The programmable controller is configured to provide an alert signal based on changes in the load data and works together in functional combination with the digitally controlled auto resetting solid-state circuit breakers to provide programmable short circuit protection and automatic circuit disconnect for over current conditions as well as reverse load polarity detecting while having self-resetting capability.

Once an over current or shorted reverse polarity output is detected, the programmable controller routinely checks for overcurrent and fault conditions to be relieved at which time a signal is sent to the digitally controlled solid-state circuit breaker which in turn automatically returns voltage and current power to the load. This provides an advantageous local resetting capability that offsets the requirements of manually replacing a fuse.

A method of use for the intelligent power management distribution system includes installing the intelligent power management distribution system, applying power to the intelligent power management distribution system, setting the manual selections via DIP switch and jumper positioning, programming the intelligent power management distribution system via a software interface, connecting the loads to the intelligent power management distribution system, and monitoring and control of the intelligent power management distribution system via software when working together in functional combination with a smart uninterruptible power supply.

The features of the invention which are believed to be novel are particularly pointed out in the specification. The present invention now will be described more fully hereinafter with reference to the accompanying drawings, which are intended to be read in conjunction with both this summary, the detailed description and any exemplary and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

The figures which accompany the written portion of this specification illustrate embodiments and method(s) of use for the present invention, power door lock assembly constructed and operative according to the teachings of the present invention.

### BRIEF DESCRIPTION OF THE DRAWINGS

FIG. 1 is a schematic view of an intelligent power distribution management system according to an embodiment of the present invention.

FIG. 2 illustrates a software programming screen view employed by an intelligent power management distribution system according to an embodiment of the present invention.

FIG. 3 illustrates a software programming screen view employed by an intelligent power management distribution system according to an embodiment of the present invention.

FIG. 4 illustrates an RS-485A address and Termination selector (SW2) employed by an intelligent power management distribution system according to an embodiment of the present invention.

### DETAILED DESCRIPTION OF THE INVENTION

Various embodiments of the present invention will hereinafter be described in conjunction with the appended drawings, wherein like designations denote like elements.

The present invention is directed to an intelligent power distribution management system. In the exemplary embodiment of the present invention, the intelligent power management distribution system includes a programmable controller, twelve supervised dry contact inputs including one Tamper input; two programmable, general purpose inputs; and eight programmable inputs for triggering programmable outputs; two RS-485 communication ports (a primary OSDP/RS-485 encrypted communication Port A and a secondary OSDP/RS-485 encrypted comm. port B) each having an API protocol; four onboard form C relays rated at 10 A; four “wet” trigger inputs for the form C relays; eight “wet” DC outputs with preset current limits each having a “wet” output voltage jumper selector, digitally controlled auto resetting solid-state circuit breakers including output current measurement capability and output current reporting capability, reverse load polarity sensing capability including signaling capability indicating to the programmable controller when a load is applied with reverse polarity; dual color output LED indicators having a first LED color when illuminated indicating normal operation and a second LED color when illuminated indicating overload/short conditions; two input power LED indicators indicating input power of 12V or 24V each having a third LED color indicating the presence of an input voltage; one Fire Alarm LED indicator indicating fire alarm status; a fourth LED color indicating the fire alarm status; two RS-485 LED indicators each having a fifth LED color indicating the presence of an RS-485 bus connection; two auxiliary power port LED indicators having a sixth LED color indicating the presence of a voltage on the power port; a DC Power IN connector; an unmanaged power output connected directly to DC Power IN connector; an onboard “Fail Safe” DIP switch including a plurality of switches; an onboard programmable RS-485 address DIP switch including a plurality of switches including an A setting switch, a B setting switch, and four address setting switches; and a fire alarm I/O interface.

The programmable controller has an algorithm that includes alarms and events reporting via dry contacts, and real-time diagnostic capability. A smart uninterruptable power supply works together in functional combination with the intelligent power management distribution system to supply the input voltage such the eight “wet” DC outputs are configured for either Fail Safe or Fail Secure operations; the first LED color when illuminated, second LED color when illuminated, a third LED color, fourth LED color, fifth LED color and a sixth LED color are all different colors each indicating a specific function or operating status as a means for providing quick information to an observer. The intelligent power management distribution system is provided a separate RS-485 connection for dedicated communication correspondence that is used to program current limits in the digitally controlled circuit breakers.

The intelligent power management distribution system's programmable controller is configured for real-time diagnostic capability and automatic recovery from reverse polarity situations for inputs and outputs. The intelligent power management distribution system inputs are managed (on/off) by an external dry contact and (on/off) by an OSDP RS-485 command.

The intelligent power management distribution system is configured to record and store load data including voltage and current over time for power door lock loads and the controller is programmed to recognize differences in load current based on the historic changes over time in the stored data as a means for determining component aging and/or failure. The intelligent power management distribution system programmable controller is configured to provide an alert signal based on changes in the load data and works together in functional combination with the digitally controlled auto resetting solid-state circuit breakers to provide programmable short circuit protection and circuit disconnect for over current conditions as well as reverse load polarity detecting while having self-resetting capability.

With respect to the predictive failure feature, the intelligent power distribution management system includes at least one sensor sensing in real time a sensed condition comprising at least one of voltage supplied to, current supplied to and power being consumed by, each of a plurality of loads, a memory on which is stored a historical record of the sensed condition for each of the plurality of loads, and a processor which compares the real time sensed condition for each of the plurality of loads with the historical record of the sensed condition for each of the plurality of loads, and predicts a likely failure of at least one of the plurality of loads based at least in part on the comparison.

In one example, the processor predicts the likely failure when the sensed condition measured in real time deviates from an average of the sensed condition stored in the historical record by more than a threshold amount. In another example, the processor predicts the likely failure when the sensed condition measured in real time deviates from a nominal baseline of the sensed condition stored in the historical record by more than a threshold amount.

The historical record may be updated periodically by storing the real time sensed condition. The frequency at which the historical record is updated may vary; for example, the frequency may fall within the range of from every three seconds to every ten seconds, with it having been found that updated every 5 seconds provide acceptable results.

The plurality of loads may comprise a plurality of electric door locks. In certain embodiments, is it desirable for the sensed condition to comprise power being consumed by each of the plurality of loads.

With respect to the automatically resetting circuit breaker feature, the intelligent power distribution management system includes at least one sensor sensing in real time a sensed condition comprising at least one of voltage supplied to, current supplied to and power being consumed by each of the plurality of loads, and a processor. The processor compares the real time sensed condition for each of the plurality of loads with a threshold for each of the plurality of loads, and terminates power to a faulty load if the comparison indicates that a fault exists based at least in part on whether the real time sensed condition exceeds the threshold. The processor automatically and periodically checks to determine whether the fault continues to exist, and upon determining that the fault no longer exists, automatically restores power to the previously determined faulty load.

In certain embodiments, the plurality of loads comprises a plurality of electric door locks. In some embodiments, it is desirable for the sensed condition to comprise current supplied to each of the plurality of loads. The fault may comprise, for example, an overcurrent situation or a short circuit situation.

In the exemplary embodiment of the intelligent power management distribution system the programmable controller includes alarms and events reporting via dry contacts, RS-485 OSDP ports, Ethernet, and WiFi, real-time diagnostic capability, and automatic recovery from reverse polarity loads applied to any of the eight “wet” outputs.

The intelligent power management distribution system is configured to measure and record load data including output voltage and load current levels over time for power door lock loads, determine component aging and/or failure based on the levels, and provide an alert of component aging to a user. The eight “wet” output outputs are designed to survive and recover from reverse load applications.

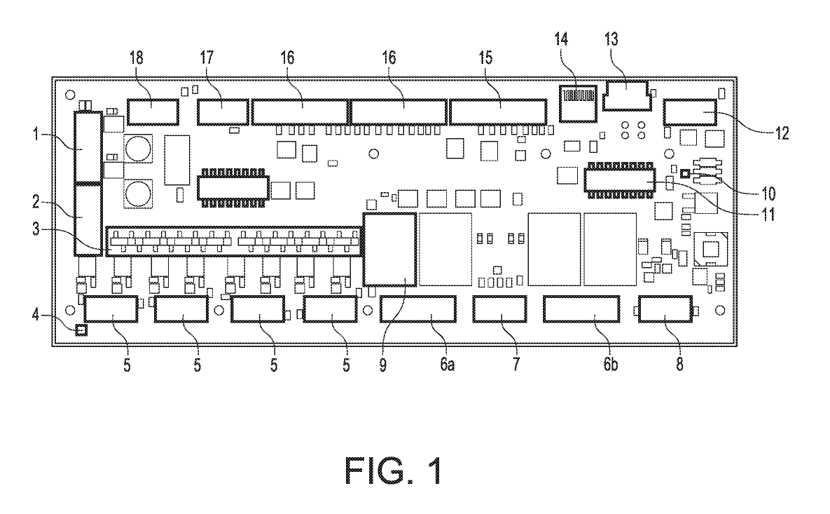

Referring now to the drawings, there is shown in FIG. 1 a schematic view of an intelligent power management distribution system according to an embodiment of the present invention having a DC Power IN connector (1) including a 12 VDC input terminal, a 24 VDC input terminal, and two ground terminals; that provides direct power to the 12 VDC and 24 VDC terminals in the unmanaged power output (2) and an auxiliary output power level of 12V/24V (8); provides current controlled power to eight “wet” DC outputs (5); a “wet” output voltage jumper selector (3) for selecting either a 12V or 24V input level; and dual color output LED indicators (4) having a first LED color when illuminated indicating normal operation and a second LED color when illuminated indicating overload/short conditions. FIG. 1 also shows the four form C Relays outputs (6a,6b) four voltage triggered inputs for the relays (7) and supervised inputs for the four Form C relays (15). Also shown in FIG. 1 are four onboard form C relays (9); one Tamper input (10); a communication address selector (11); a primary OSDP/RS-485 encrypted communications port A (17); a secondary OSDP/RS-485 encrypted communications port B (12); a programmer's input (13); the programmable controller (14); eight programmable supervised inputs (16) for triggering eight “wet” voltage outputs (5); a fire alarm I/O interface (18); and an onboard “Fail Safe” DIP switch (19).

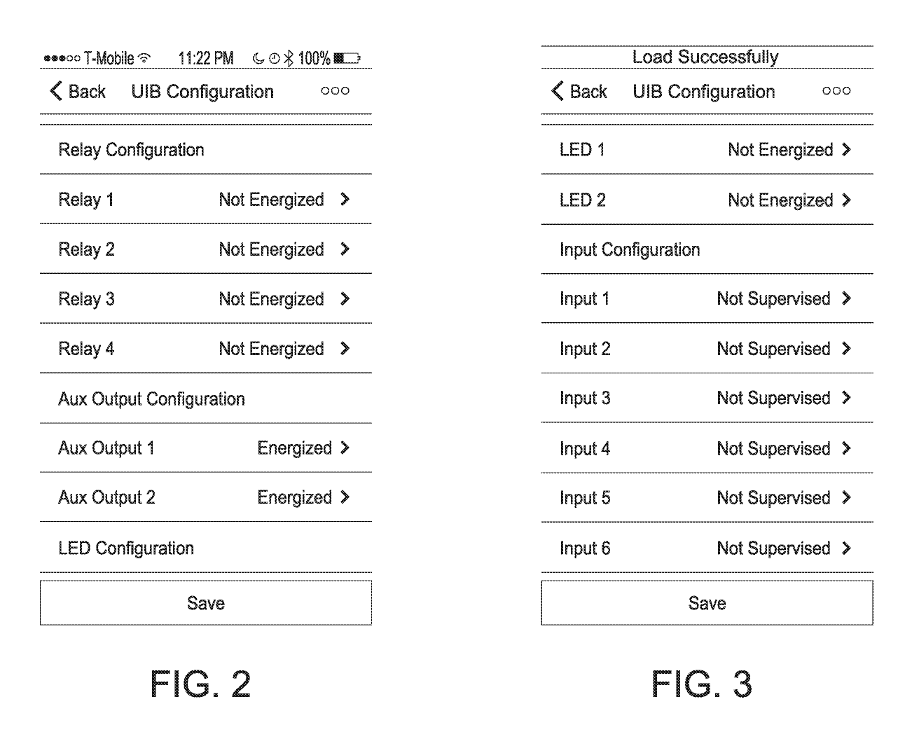

FIG. 2 illustrates a software screen of an intelligent power management distribution system according to an embodiment of the present invention. In this view the status for the four Form C relays (15) and eight “wet” voltage outputs (5) is shown.

FIG. 3 illustrates an intelligent power management distribution system showing a sample of one of the software programming screen views according to an embodiment of the present invention. In this view status of two LED indicators is shown along with the status of the four supervised inputs for the four Form C relays.

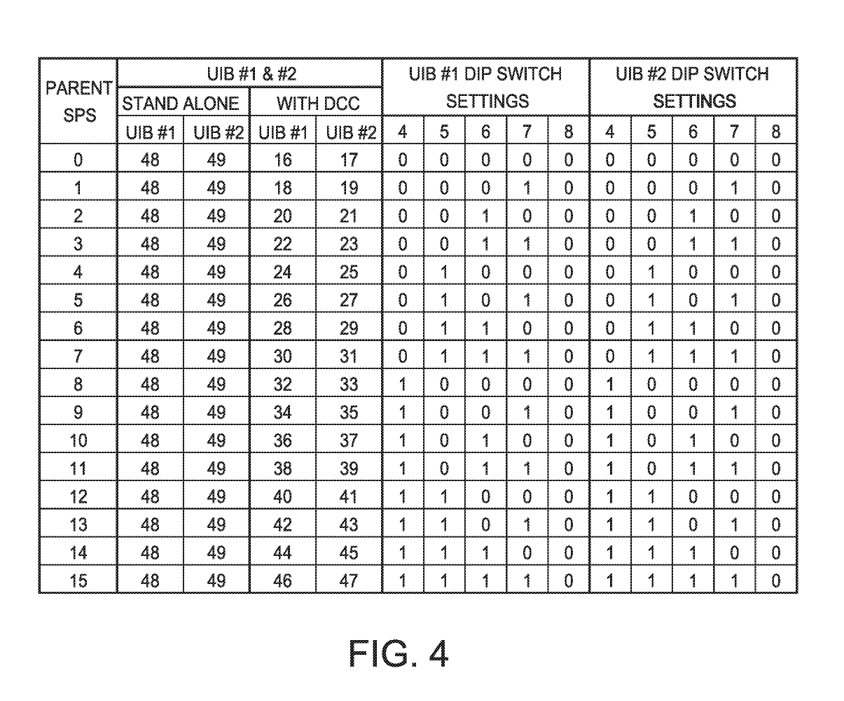

FIG. 4 illustrates an intelligent power management distribution system showing an RS-485A address and Termination selector (SW2) according to an embodiment of the present invention. The addresses of the intelligent power management distribution system are aligned with the intelligent uninterruptible power supply for the communication and display of information via the RS-45 port A bus.

The exact specifications, materials used, and method of use of the intelligent power management distribution system may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

What is claimed is:

1. An intelligent power distribution management system for managing power being supplied to a plurality of loads, said system comprising:
at least one sensor, said at least one sensor sensing in real time a sensed condition comprising at least one of voltage supplied to, current supplied to and power being consumed by each of the plurality of loads;
a memory on which is stored a historical record of the sensed condition for each of the plurality of loads; and
a processor;
wherein the processor compares the real time sensed condition for each of the plurality of loads with the historical record of the sensed condition for each of the plurality of loads, and predicts a likely failure of at least one of the plurality of loads based at least in part on the comparison; and
wherein the processor compares the real time sensed condition for each of the plurality of loads with a threshold for each of the plurality of loads, and terminates power to a faulty load if the comparison indicates that a fault exists based at least in part on whether the real time sensed condition exceeds the threshold, and wherein the processor automatically and periodically checks to determine whether the fault continues to exist, and upon determining that the fault no longer exists, automatically restores power to the previously determined faulty load.

2. The intelligent power distribution management system of claim 1 wherein the processor predicts the likely failure when the sensed condition measured in real time deviates from an average of the sensed condition stored in the historical record by more than a predetermined amount.

3. The intelligent power distribution management system of claim 1 wherein the processor predicts the likely failure when the sensed condition measured in real time deviates from a nominal baseline of the sensed condition stored in the historical record by more than a predetermined amount.

4. The intelligent power distribution management system of claim 1 wherein the historical record is updated periodically by storing the real time sensed condition.

5. The intelligent power distribution management system of claim 4 wherein the historical record is updated at a frequency falling within the range of from every three seconds to every ten seconds.

6. The intelligent power distribution management system of claim 1 wherein the plurality of loads comprises a plurality of electric door locks.

7. The intelligent power distribution management system of claim 1 wherein the sensed condition comprises power being consumed by each of the plurality of loads.

8. The intelligent power distribution management system of claim 1 wherein the sensed condition comprises current supplied to each of the plurality of loads.

9. The intelligent power distribution management system of claim 8 wherein the fault comprises an overcurrent situation or a short circuit situation.

10. An intelligent power distribution management system for managing power being supplied to a plurality of loads, said system comprising:
at least one sensor, said at least one sensor sensing in real time a sensed condition comprising at least one of voltage supplied to, current supplied to and power being consumed by each of the plurality of loads;
a memory on which is stored a historical record of the sensed condition for each of the plurality of loads; and
a processor which compares the real time sensed condition for each of the plurality of loads with the historical record of the sensed condition for each of the plurality of loads, and predicts a likely failure of at least one of the plurality of loads based at least in part on the comparison.

11. The intelligent power distribution management system of claim 10 wherein the processor predicts the likely failure when the sensed condition measured in real time deviates from an average of the sensed condition stored in the historical record by more than a threshold amount.

12. The intelligent power distribution management system of claim 10 wherein the processor predicts the likely failure when the sensed condition measured in real time deviates from a nominal baseline of the sensed condition stored in the historical record by more than a threshold amount.

13. The intelligent power distribution management system of claim 10 wherein the historical record is updated periodically by storing the real time sensed condition.

14. The intelligent power distribution management system of claim 13 wherein the historical record is updated at a frequency falling within the range of from every three seconds to every ten seconds.

15. The intelligent power distribution management system of claim 10 wherein the plurality of loads comprises a plurality of electric door locks.

16. The intelligent power distribution management system of claim 10 wherein the sensed condition comprises power being consumed by each of the plurality of loads.

17. An intelligent power distribution management system for managing power being supplied to a plurality of loads, said system comprising:
at least one sensor, said at least one sensor sensing in real time a sensed condition comprising at least one of voltage supplied to, current supplied to and power being consumed by each of the plurality of loads; and
a processor which compares the real time sensed condition for each of the plurality of loads with a threshold for each of the plurality of loads, and which terminates power to a faulty load if the comparison indicates that a fault exists based at least in part on whether the real time sensed condition exceeds the threshold, and wherein the processor automatically and periodically checks to determine whether the fault continues to exist, and upon determining that the fault no longer exists, automatically restores power to the previously determined faulty load.

18. The intelligent power distribution management system of claim 17 wherein the plurality of loads comprises a plurality of electric door locks.

19. The intelligent power distribution management system of claim 17 wherein the sensed condition comprises current supplied to each of the plurality of loads.

20. The intelligent power distribution management system of claim 19 wherein the fault comprises an overcurrent situation or a short circuit situation.
